(19) United States
(12) Patent Application Publication
(10) Pub. No.: US 2020/0031380 A1
(43) Pub. Date: Jan. 30, 2020

(54) SMART SHOPPING CART WITH ONBOARD COMPUTER

(71) Applicant: Bhagavathi Sathya Satish Kadiyala, Austin, TX (US)

(72) Inventor: Bhagavathi Sathya Satish Kadiyala, Austin, TX (US)

(21) Appl. No.: 16/524,453

(22) Filed: Jul. 29, 2019

Related U.S. Application Data
(60) Provisional application No. 62/711,962, filed on Jul. 30, 2018.

(51) Int. Cl. B62B 5/00; B62K 5/01; B62B 3/14; G01C 21/20; G01C 21/34; G05D 1/02; H04W 4/021; G06Q 20/20

(52) U.S. Cl. CPC B62B 5/0069; B62K 5/01; B62B 5/0033; B62B 3/1424; G01C 21/206; B60L 53/00; B62B 5/0096; B62B 5/00; G05D 1/0212; H04W 4/021; G06Q 20/208; G01C 21/343

(57) ABSTRACT

A smart shopping cart includes a frame defining a receptacle. A plurality of motorized wheels and a steering mechanism are coupled to the frame. The shopping cart may further include a plurality of sensors, scanners, and an onboard computing system. The onboard computing system receives data from the sensors and scanners. The onboard computing system further controls the motorized wheels and the steering mechanism. The onboard computing system includes a processor, a memory, a geolocator, a display, at least one communication interface for communicating over a network; and a plurality of program instructions stored in the memory that cause the processor to perform steps.

### CROSS-REFERENCE TO RELATED APPLICATION

This application claims the benefit of priority of U.S. provisional application No. 62/711,962, filed Jul. 30, 2018, the contents of which are herein incorporated by reference.

### BACKGROUND OF THE INVENTION

The present invention relates to an artificial intelligence (AI) shopping cart and, more particularly, to a shopping cart that has the ability to guide shoppers to items and check out the items using an onboard computer or using voice commands.

In a retail store or grocery store, a customer will typically push a shopping cart through the aisles selecting items of merchandise. Currently, if the shopper is trying to find an item, the shopper has to find a store clerk to help them. When the shopper is finished, he or she proceeds to a cash register/data terminal in a check-out area of the store. The current system is inefficient and time consuming.

This artificial intelligence (AI) mechanism is enabled to a user Mobility cart (used by senior and physically challenged people) help them interact with the cart and have them take where they want to go using onboard computer or voice commands. This cart can be used in retail outlet or outside for daily use. Multiple commands are pre-entered for easy use and better operability.

As can be seen, there is a need for an improved shopping experience using an AI shopping cart.

### SUMMARY OF THE INVENTION

In one aspect of the present invention, a shopping cart system comprises: a frame defining a receptacle; a plurality of motorized wheels; a steering mechanism; a plurality of sensors; and an onboard computing system receiving data from the sensors and controlling the motorized wheels and the steering mechanism, wherein the onboard computing system comprises a processor, a memory, a geolocator, a display, at least one communication interface for communicating over a network; and a plurality of program instructions stored in the memory that, when executed by the processor, cause the processor: receive a search query via the display or a first remote computing system over the network of at least one item within a geofenced location; determine a location of the at least one item within the geofenced location by retrieving data from the memory or from a second remote computing system over the network; and drive the shopping cart to the location of the at least one item via the geolocator, the motorized wheels, and the steering mechanism.

These and other features, aspects and advantages of the present invention will become better understood with reference to the following drawings, description and claims.

### BRIEF DESCRIPTION OF THE DRAWINGS

FIG. 1 is a side view of an embodiment of the present invention;

FIG. 2 is a front view of a display of an embodiment of the present invention;

FIG. 3 is a perspective view of an embodiment of the present invention;

FIG. 4 is a top view of an embodiment of the present invention; and

FIG. 5 is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

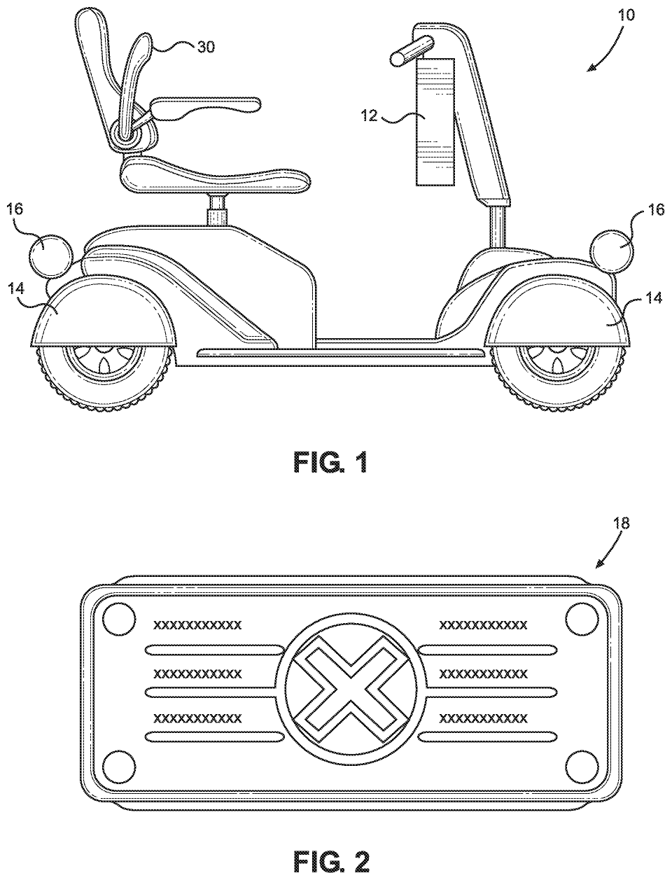

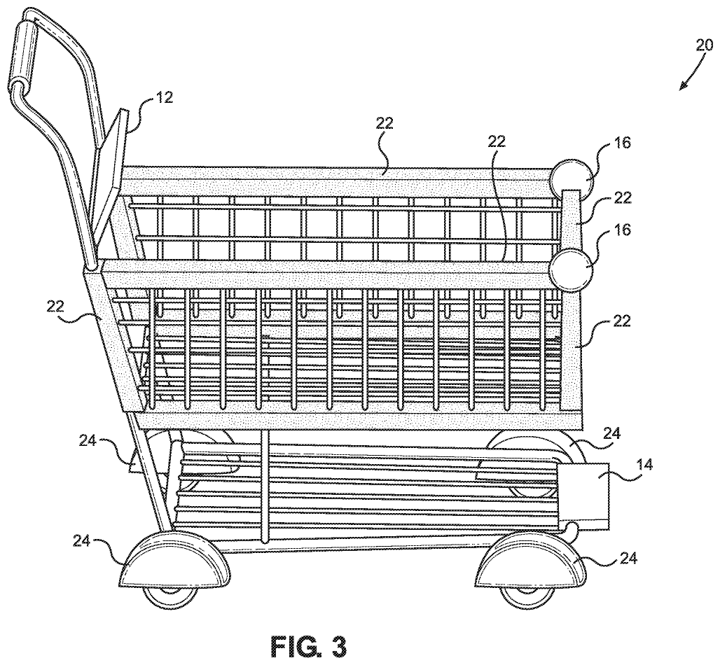

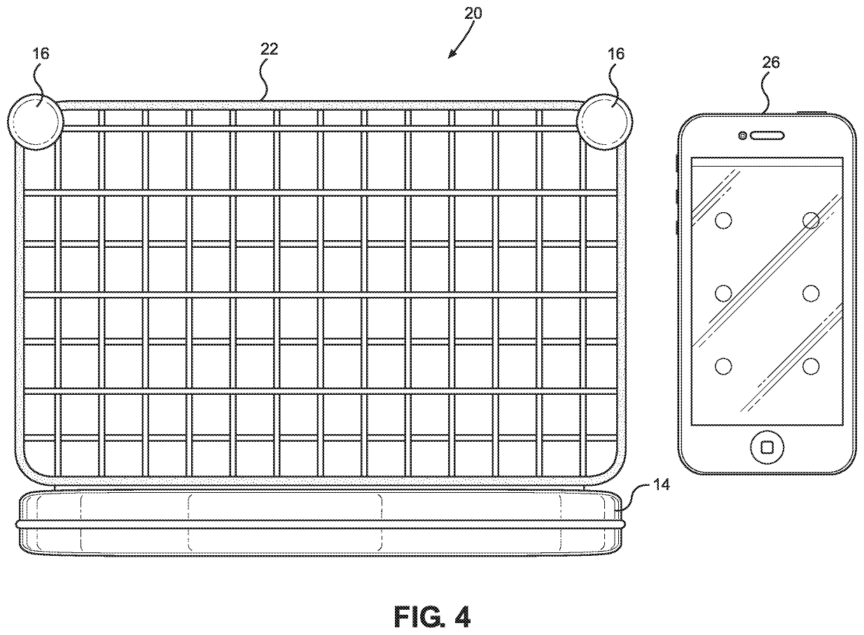

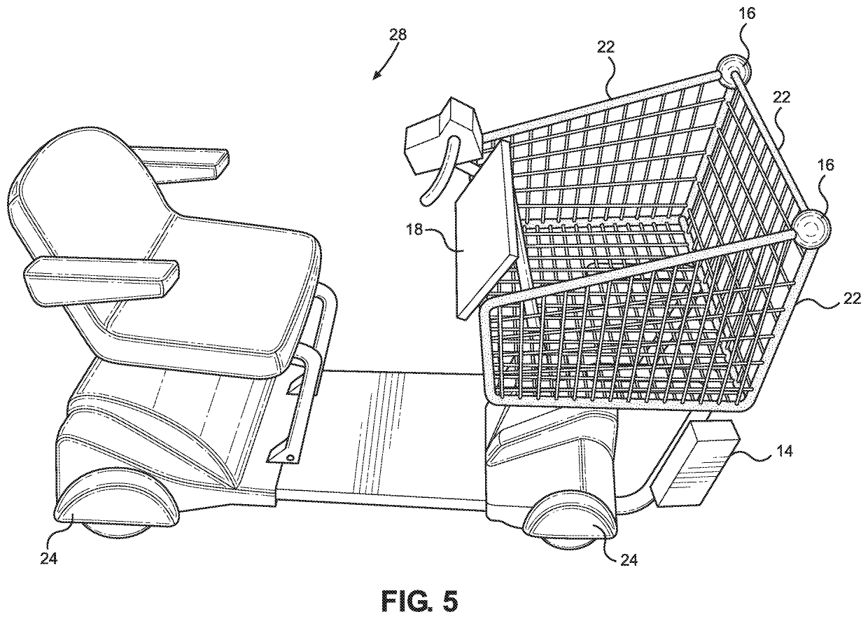

Referring to FIGS. 1 through 5, the present invention includes a smart shopping cart 20. The shopping cart 20 includes a frame 11 defining a receptacle. A plurality of motorized wheels 24 and a steering mechanism 13 are coupled to the frame 11. The shopping cart 20 may further include a plurality of sensors 14, scanners 22, and an onboard computing system 12. The onboard computing system 12 receives data from the sensors 14 and scanners 22. The onboard computing system 12 further controls the motorized wheels 24 and the steering mechanism 13. The onboard computing system 12 includes a processor, a memory, a geolocator, a display 18, at least one communication interface for communicating over a network; and a plurality of program instructions stored in the memory that cause the processor to perform steps. The shopping cart 20 may further incorporate a seat 28 for the elderly or disabled. The shopping cart 20 may include warning lights 16 coupled to the frame 11 that are turned on when the shopping cart 20 is moving.

The system of the present invention may include a centralized server. The centralized server is a computing system that wirelessly communicates with a plurality of onboard computing systems 12 to control a plurality of shopping carts 20 over the network. Additionally, a user may use their smart phone 26, which is a computing device, to communicate with the onboard computing systems 12. Using the smart device, the user may enter searches to the onboard computing systems 12 and further control the movement and direction of the shopping cart 20.

The computing systems of the present invention may include at least the processor and the memory. The computing systems may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing systems includes a processor, memory, a user interface, and a communication interface. In particular embodiments, the processor includes hardware for executing instructions, such as those making up a computer program. The memory includes main memory for storing instructions such as computer program(s) for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for user communication with the computing systems. As an example and not by way of limitation, the user interface may include a keyboard, keypad, microphone, monitor, mouse, printer, scanner, speaker, still camera, stylus, tablet, touchscreen, trackball, video camera, another user interface or a combination of two or more of these.

The communication interface includes hardware, software, or both providing one or more interfaces for communication (e.g., packet-based communication) between the computing systems and one or more other computing systems or one or more networks. As an example, and not by way of limitation, communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing system may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

The shopping carts 20 of the present invention include multiple features. In certain embodiments, the shopping cart 20 automatically follows a user. In such embodiments, a tracker is paired with a shopping cart 20. The tracker may be a smart phone 26, or a worn item, such as a bracelet. The tracker wirelessly communicates with the onboard computing system 12 over the network. The onboard computing system 12 has the shopping cart 20 follow the tracker via the motorized wheels 24 and the steering mechanism 13.

The shopping carts 20 may further include a crash prevention mechanism. In such embodiments, a plurality of proximity sensors 14 may be coupled to the frame 11. The proximity sensors 14 communication with the onboard computer 12. When the proximity sensors 14 detect an object within a threshold distance, the onboard computing system 12 stops the motorized wheels 24. For example, the threshold distance may be between about one foot and three feet.

The shopping carts 20 of the present invention may further be restricted from leaving the geofenced location. A store may include a geofenced boundary at an exit and may further include geofenced boundaries along each aisle. The geofenced boundaries prevent the shopping carts 20 from leaving the store and further keep the shopping carts 20 within the aisles. The geofenced boundaries may be created using guidance signal producing beacons on both sides of aisles and at entrance.

The shopping carts 20 may further include item detection to detect what items go in and out of the receptacle. In such embodiments, the shopping cart may include motion sensors or scanners 22 to detect items being placed within the cart and items being removed. The onboard computing system 12 tallies the items and provides a price for the items on the display 18. In certain embodiments, the onboard computing system 12 may include an integrated payment portal to receive payment for the items. Alternatively, the payment may be made using the smart phone 26.

The shopping carts 20 of the present invention may further allow a user to search and find items within a store. The onboard computer 12 may produce a map of the store on the display 18. Additionally, the onboard computer 12 may receive a search query via the display 18 or the smart phone 26 over the network of at least one item within the geofenced location. The onboard computer then determines a location of the at least one item within the geofenced location by retrieving data from the memory or from the centralized server over the network. The onboard computer 12 may then automatically drive the shopping cart 20 to the location of the at least one item via the geolocator, the motorized wheels 24, and the steering mechanism 13.

In certain embodiments, the onboard computer 12 receives a list of a plurality of items via the display 12 or the smart phone 26 over the network. The onboard computer 12 then determines locations of each of the items on the list within the geofenced location, determines a fastest route to each of the items in a consecutive order, and drives the shopping cart 20 to each of the items in the consecutive order via the geolocator, the motorized wheels 24, and the steering mechanism 13.

The electrical devices of the shopping cart 20 may be powered by a battery or other power source. In such embodiments, the present invention may include recharge station. When the power source is low, the onboard computing system directs the shopping cart to the recharge station. No human intervention is needed.

The present invention especially benefits senior citizens as they do not have to wait for a store associate for help. Instead, the artificial intelligence shopping cart 20 can take the user to where they need to be based on input on the onboard computing system 12. The present invention may further reduce lines, as users can now purchase items using the onboard computing system 12, by linking smart phone 26 or customer account to perform a mobile checkout. The shopping cart 20 may be used for the retail industry, the medical industry, and the like. As illustrated in FIG. 1, the present invention may simply include a motorized cart 10 for guiding the elderly and the disabled. Senior citizens and physically challenged users can take advantage of the voice commands and easy navigation. Multiple commands are pre-entered for easy use and better operability.

It should be understood, of course, that the foregoing relates to exemplary embodiments of the invention and that modifications may be made without departing from the spirit and scope of the invention as set forth in the following claims.

What is claimed is:

1. A shopping cart system comprising:
a power source;
a frame defining a receptacle;
a plurality of motorized wheels;
a steering mechanism;
a plurality of sensors; and
an onboard computing system receiving data from the sensors and controlling the motorized wheels and the steering mechanism, wherein the onboard computing system comprises a processor, a memory, a geolocator, a display, at least one communication interface for communicating over a network; and a plurality of program instructions stored in the memory that, when executed by the processor, cause the processor:
receive a search query via the display or a first remote computing system over the network of at least one item within a geofenced location;
determine a location of the at least one item within the geofenced location by retrieving data from the memory or from a second remote computing system over the network; and
drive the shopping cart to the location of the at least one item via the geolocator, the motorized wheels, and the steering mechanism.

2. The shopping cart system of claim 1, further comprising a tracker wirelessly communicating with the onboard computing system over the network, wherein the onboard computing system follows the tracker via the motorized wheels and the steering mechanism.

3. The shopping cart system of claim 1, wherein the plurality of sensors comprise proximity sensors, wherein when the proximity sensors detect an object within a threshold distance, the onboard computing system stops the motorized wheels.

4. The shopping cart system of claim 1, wherein the geofenced location guides the shopping cart to remain within a store and within a plurality of aisles in the store.

5. The shopping cart system of claim 1, further comprising a scanner configured to scan items placed within the receptacle, wherein the onboard computing system tallies the items and comprises a payment portal to receive payment for the items.

6. The shopping cart system of claim 1, wherein processor further produces a map of a store on the display.

7. The shopping cart system of claim 1, wherein the processor
receives a list of a plurality of items via the display or the first remote computing system over the network;
determines locations of each of the items on the list within the geofenced location;
determines a fastest route to each of the items in a consecutive order; and
drives the shopping cart to each of the items in the consecutive order via the geolocator, the motorized wheels, and the steering mechanism.

8. The shopping cart system of claim 1, wherein the first remote computing system is a mobile device and the second remote computing system is a centralized server in communication with a plurality of shopping carts.

9. The shopping cart system of claim 1, further comprising a plurality of lights activated when the shopping cart is moving.

10. The shopping cart system of claim 1, further comprising a seat coupled to the frame.

11. The shopping cart of claim 1, further comprising a recharge station, wherein when the power source is low, the onboard computing system directs the shopping cart to the recharge station.
